(19) United States
(12) Patent Application Publication
(10) Pub. No.: US 2015/0286633 A1
(43) Pub. Date: Oct. 8, 2015

(54) GENERATION, AT LEAST IN PART, OF AT LEAST ONE SERVICE REQUEST, AND/OR RESPONSE TO SUCH REQUEST

(71) Applicants: SCOTT P. DUBAL, Beaverton, OR (US); PATRICK CONNOR, Beaverton, OR (US)

(72) Inventors: SCOTT P. DUBAL, Beaverton, OR (US); PATRICK CONNOR, Beaverton, OR (US)

(21) Appl. No.: 14/248,025

(22) Filed: Apr. 8, 2014

(51) Int. Cl. G06F 17/28; H04W 28/08; H04L 29/08

(52) U.S. Cl. CPC G06F 17/289; H04L 67/10; H04W 28/08

(57) ABSTRACT

In an embodiment, first circuitry and/or second circuitry may be provided. The first circuitry may be comprised, at least in part, in at least one cloud computing network. The second circuitry may be comprised, at least in part, in at least one mobile device. The first circuitry may generate, at least in part, at least one response to at least one service request. The at least one service request may be generated, at least in part, by the second circuitry. Many modifications, alternatives, and variations are possible without departing from this embodiment.

### TECHNICAL FIELD

This disclosure relates to generation, at least in part, of at least one service request (e.g., for receipt by one or more cloud computing networks), and/or response (e.g., by the one or more cloud computing networks) to such request.

### BACKGROUND

One conventional cloud radio access network (C-RAN) consists of cell sites that communicate with a cloud computing network via optical fibre links. Cellular callers wirelessly communicate with the cell sites. The cloud computing network functions as a centralized, virtual base station (called, a baseband unit pool) that performs higher level broadband cellular signal processing, packet encoding/decoding processing, etc. The cell sites essentially function (and therefore, generally comprise only those components needed to operate) as remote radio heads and antennae for lower level cellular signal processing. Depending upon the particular implementation, the cloud computing network may provide additional services, such as, content distribution, distributed service, and/or deep packet inspection services.

In this conventional C-RAN, the cloud computing network comprises high performance compute nodes that are capable of providing significant levels of processing bandwidth. The typical functions provided by the cloud computing network in this conventional network usually do not consume a significant amount of the cloud computing network's available processing bandwidth.

### BRIEF DESCRIPTION OF THE SEVERAL VIEWS OF THE DRAWINGS

Features and advantages of embodiments will become apparent as the following Description of Embodiments proceeds, and upon reference to the Drawings, wherein like numerals depict like parts, and in which:

FIG. 1 illustrates a network system embodiment.

FIG. 2 illustrates features in an embodiment.

FIG. 3 illustrates features in an embodiment.

FIG. 4 illustrates features in an embodiment.

Although the following Description of Embodiments will proceed with reference being made to illustrative embodiments, many alternatives, modifications, and variations thereof will be apparent to those skilled in the art. Accordingly, it is intended that the claimed subject matter be viewed broadly.

### DESCRIPTION OF EMBODIMENTS

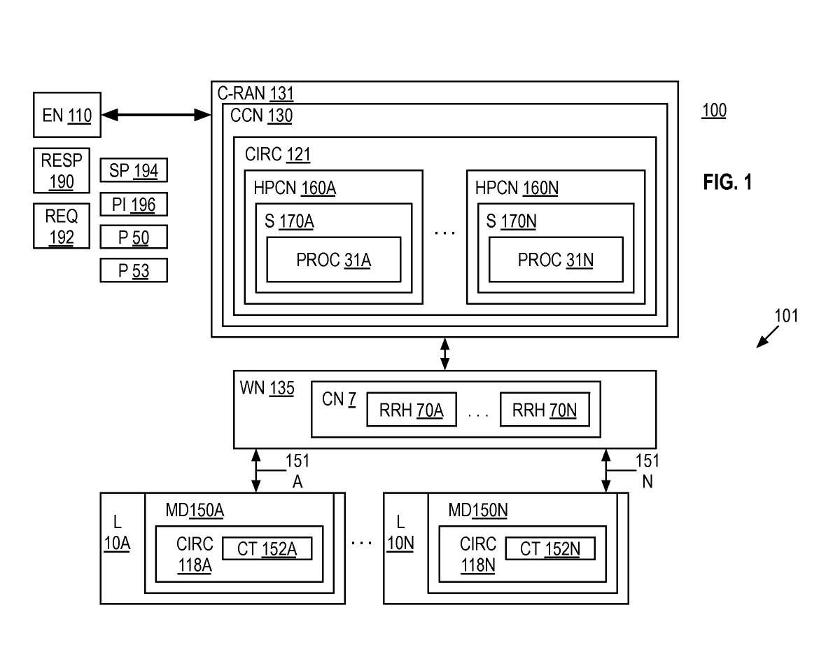

FIG. 1 illustrates a network system embodiment 100. System 100 may include, at least in part, one or more software-defined networks (SDN) 101. SDN 101 may be, comprise, be comprised in, and/or be associated with, at least in part, e.g., one or more cloud computing networks (CCN) 130 and/or cloud radio access networks (C-RAN) 131. For example, in this embodiment, one or more SDN 101 may comprise, at least in part, one or more C-RAN 131 that may comprise, at least in part, circuitry 121. One or more C-RAN 131 and/or CCN 130 may be communicatively coupled, at least in part, to one or more other networks 110 (e.g., that may be physically, logically, and/or virtually external, at least in part, to C-RAN 131 and/or CCN 130) and/or to one or more wireless networks 135.

In this embodiment, one or more C-RAN 131 may capable, at least in part, of exchanging commands and/or data via one or more communication protocols, such as, for example, one or more Long Term Evolution (LTE) protocols. An example of one such LTE protocol is disclosed in “LTE; Evolved Universal Terrestrial Radio Access (E-ULTRA) LTE Physical Layer; General Description (3GPP TS 36.201 Version 11.1.0 Release 11)”, published February 2013 by European Telecommunications Standards Institute. Of course, without departing from this embodiment, one or more C-RAN 131 may be capable of communicating using one or more other and/or additional communication protocols (including other related LTE protocols).

One or more wireless networks 135 may comprise, at least in part, one or more cellular (e.g., cellular telephone and/or data carrier) networks 7. The one or more cellular networks 7 may comprise, at least in part, one or more (and in this embodiment, a plurality of) remote radio heads and/or associated antennae and/or circuitry (RRH) 70A . . . 70N.

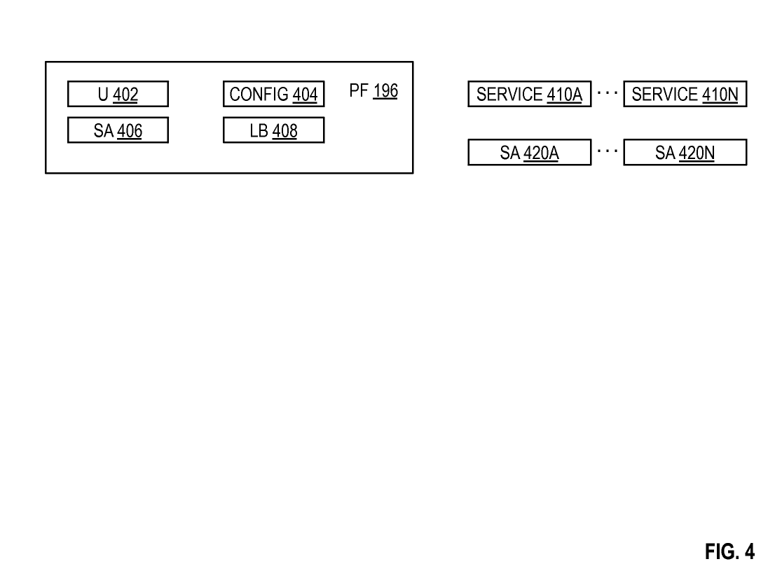

Circuitry 121 may comprise, at least in part, one or more (and in this embodiment, a plurality of, e.g., high performance) compute nodes 160A . . . 160N. Compute nodes 160A . . . 160N may be or comprise, at least in part, servers 170A . . . 170N. The servers 170A . . . 170N and/or compute nodes 160A . . . 160N may execute and/or have resident therein, at least in part, software processes 31A . . . 31N that may provide, at least in part, services (e.g., C-RAN, CCN, and/or other services) 410A . . . 410N (see, FIG. 4) that may be in accordance with features of this embodiment.

Depending upon the particular characteristics of the one or more networks 100 and/or 101, RRH 70A . . . 70N may be capable of being communicatively coupled, via one or more (and in this embodiment, a plurality of wireless/cellular communication links 151A . . . 151N, to one or more (and in this embodiment, a plurality of) mobile devices 150A . . . 150N. Mobile devices 150A . . . 150N may comprise, at least in part, respective circuitry 118A . . . 118N that may comprise, at least in part, respective cellular telephone/cellular telephone circuitry 152A . . . 152N. Mobile devices 150A . . . 150N, circuitry 118A . . . 118N, and/or cellular telephone circuitry 152A . . . 152N may be located in, transmit from, and/or receive at, at least in part, (e.g., geographic) locations 10A . . . 10N. As a result, at least in part, of being communicatively coupled to one or more of RRH 70A . . . 70N, one or more cellular networks 7, and/or one or more wireless networks 135, mobile devices 150A . . . 150N, circuitry 118A . . . 118N, and/or circuitry 152A . . . 152N may be capable of communicating via one or more of RRH 70A . . . 70N, one or more cellular networks 7, and/or one or more wireless networks 135. This may permit mobile devices 150A . . . 150N, circuitry 118A . . . 118N, and/or circuitry 152A . . . 152N to be able to exchange data and/or commands with each other, one or more CCN 130, C-RAN 131, networks 110, circuitry 121, nodes 160A . . . 160N, and/or servers 170A . . . 170N.

In this embodiment, one or more CCN 130 may facilitate, at least in part, implementation of one or more (and in this embodiment, a plurality of) virtual and/or logical computing environments (not shown) that may be associated with and/or used by, at least in part, one or more (and in this embodiment, a plurality of) users, tenants, etc., in accordance with and/or as stipulated by, at least in part, one or more (and in this embodiment, a plurality of) SDN service agreements and/or policies 420A . . . 420N. Services 410A . . . 410N may be provided in accordance with, at least in part, such agreements and/or policies. Such services 410A . . . 410N may be utilized, at least in part, by one or more of the mobile devices 150A . . . 150N and/or one or more users of the one or more such devices 150A . . . 150N, in accordance with and/or as stipulated by such service agreements and/or policies 420A . . . 420N.

In this embodiment, a (e.g., high performance) compute node may be or comprise one or more physical, logical, and/or virtual computing entities, such as, for example, one or more hosts. Also in this embodiment, the terms host computer, host, platform, server, client, network node, and node may be used interchangeably, and may mean, for example, without limitation, one or more end stations, mobile internet devices, smart phones, media devices, input/output (I/O) devices, tablet computers, appliances, intermediate stations, network interfaces, clients, servers, and/or portions thereof. In this embodiment, a network may be or comprise any mechanism, instrumentality, modality, and/or portion thereof that permits, facilitates, and/or allows, at least in part, two or more entities to be communicatively coupled together. In this embodiment, a SDN may be or comprise a network that may have one or more features, configurations, capabilities, and/or operations that may be capable of being defined, established, maintained, and/or modified, at least in part, by, under control of, and/or using, at least in part, programming, and/or one or more (e.g., software) programs, application program interfaces (API), and/or processes. In this embodiment, a policy may implement, facilitate, and/or embody, at least in part, one or more portions of one or more service agreements.

In this embodiment, a first entity may be “communicatively coupled” to a second entity if the first entity is capable of transmitting to and/or receiving from the second entity one or more commands and/or data. In this embodiment, data and information may be used interchangeably, and may be or comprise one or more commands (for example one or more program instructions), and/or one or more such commands may be or comprise data and/or information. Also in this embodiment, an instruction, program, and/or software may include data and/or one or more commands. In this embodiment, a packet may be or comprise one or more symbols and/or values. In this embodiment, a communication link may be or comprise any mechanism that is capable of and/or permits, at least in part, at least two entities to be or to become communicatively coupled. In this embodiment, a cellular telephone network may be or comprise, at least in part, circuitry capable of permitting, at least in part, cellular voice and/or data communication between at least two entities.

In this embodiment, “circuitry” may comprise, for example, singly or in any combination, analog circuitry, digital circuitry, hardwired circuitry, programmable circuitry, co-processor circuitry, state machine circuitry, and/or memory that may comprise program instructions that may be executed by programmable circuitry. In this embodiment, a processor, host processor, central processing unit (CPU), processor core, core, and/or controller each may comprise respective circuitry capable of performing, at least in part, one or more arithmetic and/or logical operations, and/or of executing, at least in part, one or more instructions.

In this embodiment, memory, cache, and cache memory each may comprise one or more of the following types of memories: semiconductor firmware memory, programmable memory, non-volatile memory, read only memory, electrically programmable memory, random access memory, flash memory, magnetic disk memory, optical disk memory, and/or other computer-readable and/or writable memory. Although not shown in the Figures, circuitry 121, nodes 160A . . . 160N, servers 170A . . . 170N, devices 150A . . . 150N, circuitry 118A . . . 118N, circuitry 152A . . . 152N, and/or other components of network 100 and/or 101 may comprise (e.g., computer-readable) memory that may store one or more instructions that when executed by, for example, these components of network 100 and/or 101 may result, at least in part, in these components performing, at least in part, the operations that are described herein as being performed, by these components. For example, the execution of such instructions by circuitry 121, nodes 160A . . . 160N, and/or servers 170A . . . 170N may result, at least in part, in circuitry 121, nodes 160A . . . 160N, and/or servers 170A . . . 170N executing, at least in part, processes 31A . . . 31N. The execution of these processes 31A . . . 31N may result, at least in part, in circuitry 121, nodes 160A . . . 160N, and/or servers 170A . . . 170N providing, at least in part, services 410A . . . 410N in accordance, at least in part, with SDN service agreements 420A . . . 420N.

In this embodiment, a portion or subset of an entity may comprise all or less than all of the entity. In this embodiment, a set may comprise one or more elements. Also, in this embodiment, a process, thread, daemon, program, driver, operating system, application, kernel, and/or virtual machine monitor each may (1) comprise, at least in part, and/or (2) result, at least in part, in and/or from, execution of one or more operations and/or program instructions. In this embodiment, an API may be or comprise one or more physical, logical, and/or virtual interfaces via which (1) a first entity provide data and/or one or more signals, commands, instructions to a second entity that may permit and/or facilitate, at least in part, control, monitoring, and/or interaction, at least in part, with the second entity, and/or (2) the second entity may provide other data and/or one or more other signals that may permit and/or facilitate, at least in part, such control, monitoring, and/or interaction, at least in part.

In this embodiment, a computing environment may be or comprise circuitry capable, at least in part, of being used, alone and/or in combination with one or more other computing environments and/or entities, to perform, at least in part, one or more operations involved in, facilitating, implementing, related to, and/or comprised in one or more arithmetic, Boolean, logical, and/or other computer-related/implemented operations and/or services. In this embodiment, a compute node may be or comprise, at least in part, one or more nodes of a computing environment. In this embodiment, a CCN may be or comprise one or more computing environments that are capable of providing one or more computer-related services in accordance with one or more service agreements. In this embodiment, a service agreement may be or comprise an agreement and/or contract between at least one entity that is to receive at least one service and at least one other entity that is to provide or to facilitate provision of the at least one service. In this embodiment, a service may comprise one or more functions, operations, instrumentalities, parameters, permissions, guarantees, interdictions, restrictions, limitations, and/or features involving, using, facilitated by, and/or implemented by, at least in part, one or more computing environments. Examples of such services will be described herein, but this description should not be viewed as limiting the type of services that may be provided in accordance with this embodiment. For example, such services may comprise, without limitation, computational, network, storage, I/O, webhosting, multimedia, video, audio, quality of service, security, power usage, network communication path selection, network congestion avoidance, and/or other services. In this embodiment, a user may be, comprise, and/or involve, at least in part, one or more human operators, one or more groups and/or associations of human operators, and/or one or more processes (e.g., application processes) associated with and/or that may be capable of being used directly or indirectly by one or more human operators, one or more groups and/or associations of human operators.

In this embodiment, interaction of a first entity with a second entity may be used interchangeably with interaction between the first and second entities. Also in this embodiment, such interaction may be, comprise, facilitate, and/or involve, at least in part, (1) provision, initiation of provision, and/or request for provision of one or more signals, commands, and/or data to the second entity by the first entity, and/or (2) one or more actions and/or changes in state of the second entity in response, at least in part, thereto.

In this embodiment, a device may be or comprise one or more physical, logical, and/or virtual entities that may comprise, at least in part, circuitry. In this embodiment, a feature set may be, involve, specify, and/or comprise one or more physical, logical, and/or virtual (1) capabilities, functions, resources, and/or operations, (2) portions of circuitry, (3) processes, (4) instructions, (5) instruction sets, and/or (6) capabilities, functions, resources, and/or operations that may result from, be used by, and/or be implementable using one or more such portions of circuitry, processes, instructions, and/or instruction sets.

Each of nodes 160A . . . 160N may have a respective construction and/or operation that may be similar and/or analogous, at least in part to each other. Alternatively, without departing from this embodiment, the nodes 160A . . . 160N may have mutually different respective constructions and/or operations, at least in part.

Additionally or alternatively, each of RRH 70A . . . 70N may have a respective construction and/or operation that may be similar and/or analogous, at least in part to each other. Alternatively, without departing from this embodiment, the RRH 70A . . . 70N may have mutually different respective constructions and/or operations, at least in part.

Additionally or alternatively, each of devices 150A . . . 150N may have a respective construction and/or operation that may be similar and/or analogous, at least in part to each other. Alternatively, without departing from this embodiment, the devices 150A . . . 150N may have mutually different respective constructions and/or operations, at least in part.

Additionally or alternatively, each of circuitry 118A . . . 118N may have a respective construction and/or operation that may be similar and/or analogous, at least in part to each other. Alternatively, without departing from this embodiment, circuitry 118A . . . 118N may have mutually different respective constructions and/or operations, at least in part.

Additionally or alternatively, each of circuitry 152A . . . 152N may have a respective construction and/or operation that may be similar and/or analogous, at least in part to each other. Alternatively, without departing from this embodiment, circuitry 152A . . . 152N may have mutually different respective constructions and/or operations, at least in part.

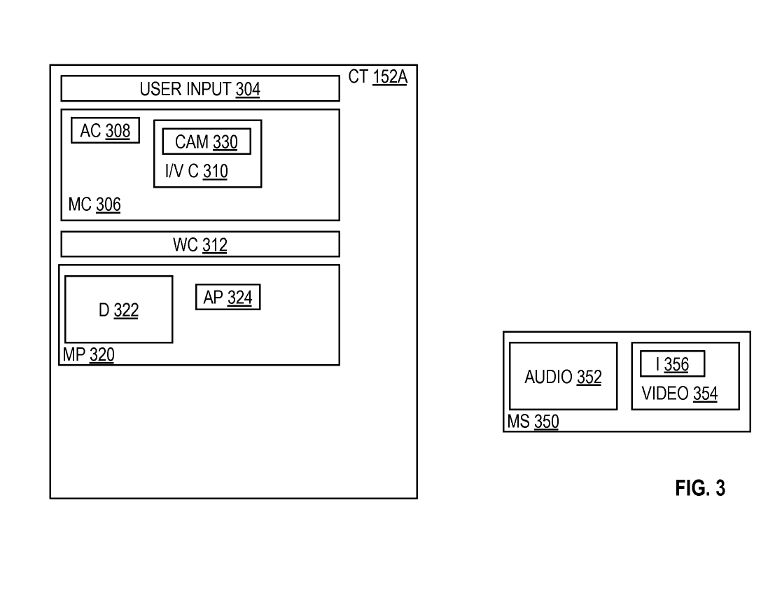

By way of example, each of mobile devices 150A . . . 150N, circuitry 118A . . . 118N, and/or circuitry 152A . . . 152N may comprise, at least in part, components that may be similar and/or analogous to those shown in FIG. 3. For example, one or more devices 150A, circuitry 118A, and/or circuitry 152A may comprise, at least in part, one or more (e.g., graphical, touch screen, pointing device, track ball, etc.) user input devices 304, media capture devices 306, wireless and/or cellular communication devices 312, and/or media playback devices 320. In this example, one or more media capture devices 306 may comprise one or more audio capture (e.g., recording) devices 308, and/or image and/or video capture (e.g., recording) devices 310. One or more image and/or video capture devices 310 may comprise, for example, one or more still image and/or video cameras 330. One or more media playback devices 320 may comprise, for example, one or more still image and/or video display/playback devices 322 and/or audio speakers/playback devices 324. One or more devices 304 may permit a user human operator to be able to input commands and/or data to one or more devices 150A, circuitry 118A, circuitry 152A, and/or components thereof. One or more communication devices 312 may permit, at least in part, one or more devices 150A, circuitry 118A, circuitry 152A, and/or one or more components thereof to be able to communicate and/or exchange data and/or commands with one or more of the RRH 70A . . . 70N, one or more wireless networks 135, and/or cellular networks 7, via one or more links 151A.

In operation, one or more CCN 130, circuitry 121, nodes 160A . . . 160N, and/or servers 170A . . . 170N may function, at least in part, as one or more baseband unit pools performing certain broadband cellular signal processing, packet encoding/decoding processing, and/or other processing. Additionally or alternatively, one or more CCN 130, circuitry 121, nodes 160A . . . 160N, and/or servers 170A . . . 170N may provide one or more of services 410A . . . 410N to one or more of the devices 150A . . . 150N, circuitry 118A . . . 118N, circuitry 152A . . . 152N, and/or users thereof. The provision of these one or more such services 410A . . . 410N may be in response to and/or based upon, at least in part, one or more requests and/or service parameters directly and/or indirectly generated by, obtained from, and/or derived from, at least in part, these one or more of the devices 150A . . . 150N, circuitry 118A . . . 118N, circuitry 152A . . . 152N, networks 135, networks 7, and/or users thereof.

For example, based upon and/or in response, at least in part, to one or more user commands provided to one or more (e.g., 150A) of the mobile devices 150A . . . 150N, via one or more user input devices 304, one or more mobile devices 150A, circuitry 118A, and/or circuitry 152A may generate and/or transmit, at least in part, one or more service requests 192 and/or service parameters 194 to one or more CCN 130, via one or more links 151A, networks 135, and/or networks 7. Additionally or alternatively, without departing from this embodiment, one or more service requests 192 and/or parameters 194 may be generated and/or transmitted, at least in part, by one or more networks 135 and/or 7 to one or more CCN 130 (e.g., in response, at least in part, to these one or more commands). One or more service requests 192 may request, at least in part, that one or more CCN 130 provide, at least in part, one or more services (e.g., 410A) to one or more devices 150A, circuitry 118A, and/or circuitry 152A. One or more service parameters 194 may be based upon, at least in part, profile information 196. Profile information 196 may be based upon, derived from, obtained from, and/or associated, at least in part, with (1) the one or more CCN 130 that are to provide, at least in part, the one or more requested services 410A, (2) one or more wireless networks 135 and/or cellular networks 7 via which the one or more mobile devices 150A communicate with the one or more CCN 130, and/or (3) the one or more requesting mobile devices 150A and/or users thereof.

One or more CCN 130, circuitry 121, nodes 160A . . . 160N, and/or servers 170A . . . 170N may receive, at least in part, one or more service requests 192 and/or parameters 194 via one or more wireless networks 193 and/or cellular networks 7. In response to and/or based upon, at least in part, the one or more service requests 190 and/or parameters 192, one or more CCN 130, circuitry 121, nodes 160A . . . 160N, and/or servers 170A . . . 170N may generate, at least in part, one or more responses 190 to one or more service requests 192. One or more responses 190 may be, comprise, and/or constitute, at least in part, provision, at least in part, of the one or more requested services 410A to one or more devices 150A, circuitry 118A, and/or circuitry 152A.

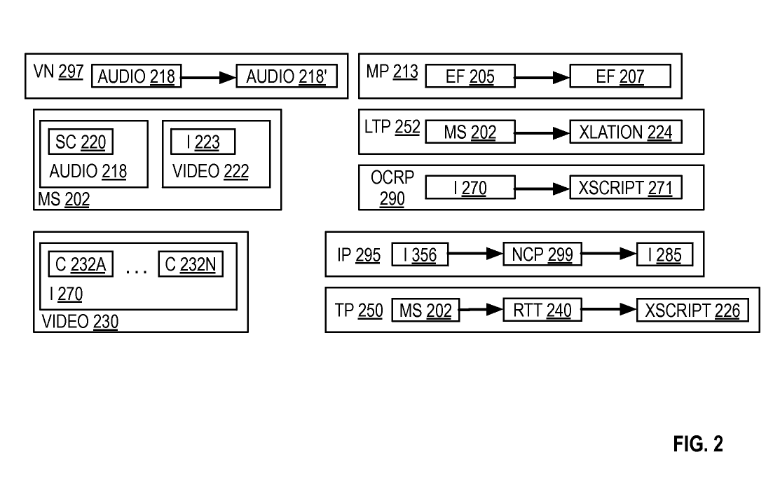

In this embodiment, the one or more service requests 192 may request provision of, and/or one or more requested services 410A may be, comprise, and/or correspond to, at least in part, one or more certain types of processing and/or associated data that one or more CCN 130, nodes 160A . . . 160N, servers 170A . . . 170N, and/or circuitry 121 may be capable of providing, and/or generating, at least in part. For example, as is shown symbolically in FIG. 2, the one or more service requests 192 may request, and/or one or more requested services 410A may be, comprise, and/or correspond to, at least in part, one or more of the following types of processing: (1) transcription processing 250 of one or more media streams 202, (2) language translation processing 252 of one or more streams 202, (3) modification processing 213 of one or more encodings (e.g., encoding formats 205) of one or more streams 202, (4) character recognition processing 290 of one or more images 270, (5) image processing 295 of one or more images 270, and/or (6) volume normalization processing 297 of one or more media streams 202. Each of these types of processing is described below in greater detail. Of course, the types, nature, characteristics, etc. of the processing that one or more CCN 130, nodes 160A . . . 160N, servers 170A . . . 170N, and/or circuitry 121 may be capable of providing, and/or generating, at least in part, in response, at least in part, to one or more requests 192 and/or parameters 194, may be other than and/or in addition to those described herein. Accordingly, the types, nature, characteristics, etc. of such processing described herein should be viewed as exemplary and/or illustrative, and this embodiment should not be viewed as being limited thereto.

In this embodiment, a media stream may comprise at least one packet that comprises, represents, indicates, encodes, conveys, and/or embodies, at least in part, audio information and/or video information. In this embodiment, audio information may comprise, at least in part, information that may be used to facilitate, at least in part, playback, generation, reproduction, displaying, and/or reconstruction, at least in part, one or more sounds, such as, for example, without limitation, ambient sound, music, and/or speech. In this embodiment, video information may comprise, at least in part, information that may be used to facilitate, at least in part, playback, generation, reproduction, displaying, and/or reconstruction, at least in part, one or more one or more images, such as, for example, without limitation, still and/or motion picture images. In this embodiment, transcription may comprise, at least in part, generating, at least in part, a written and/or textual representation of speech. In this embodiment, language translation may comprise, at least in part, translating writing or speech of at least one language into writing or speech of at least one other language. Also in this embodiment, an encoding and/or encoding format of a media stream may comprise, at least in part, at least one manner in which the audio and/or video information is represented, indicated, encoded, conveyed, and/or embodied in the media stream. In this embodiment, volume normalization may comprise, at least in part, modifying, at least in part, input audio information such that when the modified audio information is used to facilitate, at least in part, playback, generation, reproduction, displaying, and/or reconstruction, at least in part, of one or more sounds, the one or more sounds may exhibit at least one volume level that differs from that which would result if the input audio information were to be used to facilitate, at least in part, playback, generation, reproduction, displaying, and/or reconstruction, at least in part, of one or more sounds.

In this embodiment, the one or more media streams 202 and/or images 270 may be initially obtained, at least in part, for processing, from (1) one or more networks 110 and/or (2) one or more devices 150A, circuitry 118A, and/or circuitry 152A. Thus, in this embodiment, in the first of these two cases, one or more media streams 202 and/or one or more images 270 may be transmitted, at least in part, from the one or more networks 110 to the one or more CCN 130, nodes 160A . . . 160N, servers 170A . . . 170N, and/or circuitry 121 for processing by the one or more CCN 130, nodes 160A . . . 160N, servers 170A . . . 170N, and/or circuitry 121. After such processing has occurred, the resultant output of such processing may be transmitted from the one or more CCN 130, nodes 160A . . . 160N, servers 170A . . . 170N, and/or circuitry 121 to the one or more devices 150A, circuitry 118A, and/or circuitry 152A. Alternatively or additionally, without departing from this embodiment, in the second of these two cases, one or more media streams 202 and/or one or more images 270 may be transmitted, at least in part, from the one or more devices 150A, circuitry 118A, and/or circuitry 152A to the one or more CCN 130, nodes 160A . . . 160N, servers 170A . . . 170N, and/or circuitry 121 for processing by the one or more CCN 130, nodes 160A . . . 160N, servers 170A . . . 170N, and/or circuitry 121. After such processing has occurred, the resultant output of such processing may be transmitted from the one or more CCN 130, nodes 160A . . . 160N, servers 170A . . . 170N, and/or circuitry 121 to the one or more devices 150A, circuitry 118A, and/or circuitry 152A. In either of two cases, the obtaining and/or transmission of the one or more media streams 202 and/or images 270 for processing by the one or more CCN 130, nodes 160A . . . 160N, servers 170A . . . 170N, and/or circuitry 121 may be directly and/or indirectly initiated, at least in part, by one or more user commands provided to one or more mobile devices 150A, via one or more user input devices 304, and/or by one or more requests 192. Alternatively or additionally, without departing from this embodiment, the obtaining and/or transmission of the one or more media streams 202 and/or images 270 for such processing may be directly and/or indirectly initiated, at least in part, as a result, at least in part, of one or more other types of requests (e.g., for provision of media and/or other content, etc.) generated, at least in part, by the one or more devices 150A, circuitry 118A, and/or circuitry 152A, one or more CCN 130, nodes 160A . . . 160N, servers 170A . . . 170N, and/or circuitry 121, one or more networks 135, one or more networks 7, and/or other components of one or more networks 100 and/or 101.

Transcription processing 250 may comprise, at least in part, generating, at least in part, one or more written and/or text transcripts 226 of the speech content 220 of audio information 218 comprised, at least in part, in one or more media streams 202. For example, one or more media streams 202 may comprise, at least in part, audio information 218 and/or video information 222. Audio information 218 may comprise, at least in part, speech content (e.g., of words spoken in a certain human language). As part of transcription processing 250, one or more CCN 130, nodes 160A . . . 160N, servers 170A . . . 170N, and/or circuitry 121 may perform, at least in part, real-time and/or near real-time transcription processing 240 that may result, at least in part, in one or more transcripts 226 in one or more local (and/or other) languages of the spoken content 220. Such processing 240 may comprise, at least in part, text and/or other pattern matching based at least in part upon language dictionary information, audio information 218, and/or content 220. These one or more local languages may be, comprise, and/or be associated, with, at least in part, one or more languages that may be considered prevalent and/or commonly spoken in and/or associated with the one or more locations 10A of the one or more mobile devices 150A. For example, if the one or more locations 10A are located within the continental United States, and the spoken content 220 is in Spanish, the resultant transcript 226 may be in English. Alternatively or additionally, these one or more local languages may be, comprise, and/or be associated, with, at least in part, one or more languages that may be desired, selected, and/or preferred, at least in part, by one or more human users of the one or more mobile devices 150A.

One or more CCN 130, nodes 160A . . . 160N, servers 170A . . . 170N, and/or circuitry 121 may determine, at least in part, these one or more local languages based, at least in part, upon profile information 196. Profile information 196 may be, comprise, and/or be associated with, at least in part, various sources of information useful in providing high-value added services 410A . . . 410N.

For example, as shown in FIG. 4, profile information 196 may comprise, at least in part, usage information 402, configuration information 404, service agreement information 406, and/or load balancing information 408. Such information 402, 404, 406, and/or 408 may be based upon, derived from, obtained from, and/or associated with, at least in part, one or more (1) CCN 130, (2) wireless networks 135 and/or cellular networks 7, and/or (3) mobile devices 150A and/or users thereof. Such profile information 196 may reside in and/or be obtained from, at least in part, one or more CCN 130, wireless networks 135, cellular networks 7, and/or mobile devices 150A, as appropriate, given the particular configuration of network 100 and/or network 101. Depending upon the particular information in question, the information 196 may be gathered, as appropriate, via direct or indirect user and/or administrator input, and/or via (e.g., automatic) information gathering of one or more CCN 130, wireless networks 135, cellular networks 7, and/or mobile devices 150A.

For example, usage information 402 may comprise, at least in part, information concerning the current usage and/or previous (e.g., historical) usage patterns of the one or more devices 150A and/or users thereof. For example, such current and/or historical usage pattern information may relate to geographical locations/countries/regions of use, bandwidth usage, world wide web addresses accessed, times/dates of use, etc. In the case of geographical locations/countries/regions may be obtainable and/or classifiable based at least in part upon country calling codes dialed and/or associated with the one or more locations 10A and/or other parties (not shown) involved in communications with the one or more devices 150A.

Configuration information 404 may comprise, at least in part, information related to and/or associated with, at least in part, the particular capabilities of and/or user preferences concerning one or more devices 150A, networks 135, networks 7, user-input devices 304, media capture devices 306, audio capture devices 308, image/video capture devices 310, cameras 330, wireless communication devices 312, media playback devices 320, displays 322, and/or audio playback devices 324. For example, such information 404 may indicate, at least in part, the particular languages, screen format, encoding, resolution, size, image/video properties, etc. available and/or to be used in connection with the one or more display devices 322, media playback devices 320, and/or user-input devices 304. Also, for example, such information 404 may indicate, at least in part, the particular media encoding, codecs, pixel resolutions, focal lengths, aspect ratios, shutter/frame speeds, image/video properties, etc. available and/or to be used in connection with the one or more media capture devices 310 and/or cameras 330. Additionally, for example, such information 404 may indicate, at least in part, the particular languages, media encoding, codecs, dynamic ranges, audio properties, etc. available and/or to be used in connection with the one or more media capture devices 310, audio capture devices 308, media playback devices 320, and/or audio playback devices 324. Additionally, for example, such information 404 may indicate, at least in part, the communication protocols usable and/or to be used by one or more communication devices 312, networks 135, and/or networks 7 for communications via one or more links 151A.

For example, at least with respect to image/video information recording and/or playback, the particular information 404 associated with the one or more devices 150A may differ depending, at least in part, upon the particular country or regional location in which the one or more devices 150A are intended to operate. For example in certain countries/regions, such image/video information recording and/or playback may be in accordance with the Phase Alternating Line (PAL) Standard set forth in Recommendation ITU-R BT.470-6, Conventional Television Systems, 1998, International Telecommunication Union. Also, for example, in other countries/regions, such recording and/or playback may be in accordance with the National Television System Committee (NTSC) Standard set forth in Recommendation ITU-R BT.470-7, Conventional Analog Television Systems, 1998, International Telecommunication Union. Many alternatives are possible without departing from this embodiment.

Service agreement information 406 may indicate, at least in part, the one or more particular service agreement (e.g., 420A) that may be associated with the one or more mobile devices 150A and/or users thereof. Alternatively or additionally, such information 406 may comprise, at least in part, pertinent particulars related to such one or more service agreements 420A (e.g., as may be related to the particular services that may be available given the one or more service agreements 420A, the particular manner of delivery, quality of service, bit rate and/or bandwidth to be provided, and/or priority of service to be used in connection with the provision of such services, etc.).

Load balancing information 408 may indicate, at least in part, the particular manner in which one or more networks 135, 7, 131, and/or 130 are to balance processing and/or other load among their respective nodes, components, and/or processes in providing services to one or more mobile devices 150A, in order to provide requested services in an appropriate manner given the requirements of the respective service agreements. For example, depending upon the particular service agreement 420A and the loading of one or more nodes 160A, servers 170A, and/or processes 31A, information 408 may indicate that the processing associated with providing one or more requested services 410A may be reassigned, at least in part and/or at least temporarily, to be performed, at least in part, by one or more other nodes 160N, servers 170N, and/or processes 31N. Alternatively, depending upon the particular service agreement 420A and the loading of one or more nodes 160A, servers 170A, and/or processes 31A, information 408 may indicate that the processing associated with providing one or more requested services 410A may wait to be performed until such time as additional processing resources of one or more nodes 160A, servers 170A, and/or processes 31A become available. Further additionally or alternatively, information 408 may indicate that the processing associated with providing one or more requested services 410A may be provided at reduced bit rate/quality until such time as further such resources become available.

Returning now to the case of transcription processing 250, contemporaneously with the provision of one or more media streams 202 to one or more devices 150A, one or more CCN 130, nodes 160A . . . 160N, servers 170A . . . 170N, and/or circuitry 121 may perform, at least in part, real-time or near real-time transcription processing 240 that may result, at least in part, in one or more transcripts 226 being provided to one or more devices 150A. More specifically, one or more CCN 130, nodes 160A . . . 160N, servers 170A . . . 170N, and/or circuitry 121 may provide to one or more devices 150A, contemporaneously with the provision of the one or more media streams 202, one or more packets 50 that may comprise, at least in part, the one or more transcripts 226, such that the delivery, display, and/or playback of relevant portions of the one or more streams 202 and the one or more transcripts 226 are synchronized, at least in part, with each other. Advantageously, this may permit the delivery to, display at, and/or playback at one or more mobile devices 150A of both (1) the one or more transcripts 226 and (2) the corresponding portions of the one or more media streams 202, content 220, and/or audio information 218 to be synchronized, at least in part, with each other (e.g., at least from the standpoint of the perception of a human user).

Additionally or alternatively, one or more services 410A may comprise, at least in part, language translation processing 252 that is based, at least in part, upon profile information 196. Translation processing 252 may comprise, at least in part, generating, at least in part, one or more verbal and/or written translations 224 of the speech content 220 of audio information 218. For example, as part of translation processing 252, one or more CCN 130, nodes 160A . . . 160N, servers 170A . . . 170N, and/or circuitry 121 may perform, at least in part, real-time and/or near real-time translation processing 252 that may result, at least in part, in one or more translations 224 into one or more local (and/or other) languages of the spoken content 220 from one or more other languages in which the spoken content 220 may be. Such processing 252 may comprise, at least in part, text and/or other pattern matching based at least in part upon language dictionary information, audio information 218, and/or content 220.

In this example, contemporaneously with the provision of one or more media streams 202 to one or more devices 150A, one or more CCN 130, nodes 160A . . . 160N, servers 170A . . . 170N, and/or circuitry 121 may perform, at least in part, real-time or near real-time translation processing 252 that may result, at least in part, in one or more translations 224 being provided to one or more devices 150A. More specifically, one or more CCN 130, nodes 160A . . . 160N, servers 170A . . . 170N, and/or circuitry 121 may provide to one or more devices 150A, contemporaneously with the provision of the one or more media streams 202, one or more packets 50 that may comprise, at least in part, the one or more translations 224, such that the delivery, display, and/or playback of relevant portions of the one or more streams 202 and the one or more translations 224 may be synchronized, at least in part, with each other.

Advantageously, this may permit the delivery to, display at, and/or playback at one or more mobile devices 150A of both (1) the one or more translations 224 and (2) the corresponding portions of the one or more media streams 202, content 220, and/or audio information 218 to be synchronized, at least in part, with each other (e.g., at least from the standpoint of the perception of a human user).

Additionally or alternatively, one or more services 410A may comprise, at least in part, modification processing 213 that is based at least in part upon profile information 196. Modification processing 213 may comprise, at least in part, generating, at least in part, one or more re-encodings (e.g., into one or more other encoding formats 207) of audio information 218, video information 222, and/or one or more images 223 from one or more initial encoding formats 205 thereof. Such one or more other encoding formats 207 may be suitable and/or better suited for processing, display, and/or playback by one or more mobile devices 150A, than the one or more encoding formats 205 may be. For example, the display size, screen format, aspect ratio, and/or resolution size, video/audio codec capabilities, etc. of the one or more input devices 304, media playback devices 320, display devices 322, and/or audio playback devices 324 may be suitable (or better suitable) for processing and/or utilizing one or more formats 207 than for one or more formats 205. For example, as part of modification processing 213, one or more CCN 130, nodes 160A . . . 160N, servers 170A . . . 170N, and/or circuitry 121 may perform, at least in part, real-time and/or near real-time modification processing 213 that may result, at least in part, in one or more media streams 350 (see FIG. 3), audio information 352, video information 354, and/or one or more images 356. One or more media streams 350, audio information 352, video information 354, and/or one or more images 356 may be in one or more encoding formats 207, but may correspond, at least in part, respectively, in substance to one or more media streams 202, audio information 218, video information 222, and/or one or more images 223. For example, such processing 213 may comprise, at least in part, changing from a PAL encoding to an NTSC encoding (or vice versa), changing screen size/format/aspect ratio, video/audio codec capabilities, etc. so as to permit appropriate, proper, and/or best possible display and/or playback by one or more mobile devices 150A. The one or more encoding formats 207 may be selected, at least in part, by one or more CCN 130, nodes 160A . . . 160N, servers 170A . . . 170N, and/or circuitry 121 based, at least in part, upon one or more locations 10A.

Additionally or alternatively, one or more services 410A may comprise, at least in part, optical character recognition processing 290 that may be based at least in part upon profile information 196 and/or one or more images 270. In this embodiment, recognition processing 290 may differ, at least in part, depending upon whether the one or more images 270 that are to undergo processing 290 resulted from image capture by the one or more mobile devices 150A, or from another image capture process (and therefore are received from one or more networks 110 for processing). For example, if one or more images 270 are received from one or more networks 110 (e.g., as part of video information 230 extracted, at least in part, from video information 222), one or more CCN 130, nodes 160A . . . 160N, servers 170A . . . 170N, and/or circuitry 121 may perform, at least in part, optical character recognition processing 290 upon one or more images 270 that may result, at least in part, in determination of one or more (and in this example, a plurality of) recognized characters 232A . . . 232N. One or more CCN 130, nodes 160A . . . 160N, servers 170A . . . 170N, and/or circuitry 121 may perform textual analysis upon recognized characters 232A . . . 232N to determine and/or build, at least in part, the best natural language fit/match for those characters 232A . . . 232N to proper words, phrases, sentences, etc., given the language and syntax of the one or more local (and/or other) languages. Based at least in part upon this best natural language fit/match, as part of process 290, one or more CCN 130, nodes 160A . . . 160N, servers 170A . . . 170N, and/or circuitry 121 may construct one or more transcripts 271 that may reflect this best fit/match. Based at least in part upon profile information 196, one or more CCN 130, nodes 160A . . . 160N, servers 170A . . . 170N, and/or circuitry 121 may determine one or more most appropriate encoding formats 207 for processing, display, and/or playback by one or more mobile devices 150A, and may issue one or more packets 53 to one or more mobile devices 150A that may encode one or more transcripts 271 in these one or more formats 207.

Alternatively, without departing from this embodiment, one or more images 270 may result, at least in part, from image capture by one or more mobile devices 150A. For example, one or more media capture devices 306 may capture, at least in part, one or more media streams 350. One or more media streams 350 may comprise, at least in part, audio information 352 that may be captured, at least in part, by one or more audio capture devices 308, and video information 354 and one or more images 356 that may be captured, at least in part, by one or more image capture devices 310 and/or cameras 330. One or more mobile devices 150A may transmit, at least in part, one or more streams 350 to one or more CCN 130, nodes 160A . . . 160N, servers 170A . . . 170N, and/or circuitry 121. In this case, based at least in part upon the audio, video, and/or image capture capabilities and/or limitations of devices 306, 308, 310, and/or 330 indicated in profile information 196, one or more CCN 130, nodes 160A . . . 160N, servers 170A . . . 170N, and/or circuitry 121 may perform image processing 295 upon one or more streams 350, video information 354, and/or one or more images 356. For example, such image processing 295 may comprise, at least in part, image normalization and/or (e.g., gamma) correction processing 299 to correct distortion, brightness, contrast, and/or other errors in one or more images 356 to produce, at least in part, one or more corrected images 285. One or more CCN 130, nodes 160A . . . 160N, servers 170A . . . 170N, and/or circuitry 121 may extract, at least in part, from one or more corrected images 285, one or more images 270. Thereafter, one or more images 270 may perform recognition processing 290 upon one or more images 270 in the manner described previously.

Additionally or alternatively, without departing from this embodiment, image processing 295 and/or 299 may be performed, at least in part, independently of use in connection with processing 290. One or more corrected images 285 may be uploaded to network 110 and/or provided to one or more devices 150A by one or more CCN 130, nodes 160A . . . 160N, servers 170A . . . 170N, and/or circuitry 121.

Additionally or alternatively, without departing from this embodiment, one or more services 410A may comprise, at least in part, audio volume normalization processing 297 of one or more streams 202 and/or 350. It should be understood that although the following description will proceed with reference to such processing 297 being performed on one or more streams 202, it could be performed upon one or more streams 350 using similar or analogous techniques, without departing from this embodiment. For example, profile information 196 and/or configuration information 404 may indicate, at least in part, one or more (e.g., user-specified) maximum and/or minimum audio volume levels and/or ranges for audio playback (e.g., via one or more audio playback devices 324). After receiving one or more streams 202, as part of processing 297, one or more CCN 130, nodes 160A . . . 160N, servers 170A . . . 170N, and/or circuitry 121 examine the actual maximum and/or minimum audio volume levels and/or ranges encoded and/or reflected, at least in part, in audio information 218 to determine, at least in part, whether these actual maximum and/or minimum audio volume levels and/or ranges comport with the user-specified maximum and/or minimum audio volume levels and/or ranges indicated, at least in part, in profile information 196. As part of processing 297, one or more CCN 130, nodes 160A . . . 160N, servers 170A . . . 170N, and/or circuitry 121 may modify, at least in part, audio information 218 so as to produce audio information 218′. In substance, audio information 218′ may correspond, at least in part, to audio information 218, except that the actual maximum and/or minimum audio volume levels and/or ranges reflected in audio information 218′ may wholly comport with the user-specified maximum and/or minimum audio volume levels and/or ranges. One or more media streams 202 containing audio information 218′ (instead of audio information 218) may be transmitted to one or more media devices 150A by one or more CCN 130, nodes 160A . . . 160N, servers 170A . . . 170N, and/or circuitry 121.

Many alternatives are possible. For example, without departing from this embodiment, above techniques that have been described as being used as part of processing 250, 213, and/or 252 to process, at least in part, one or more media streams 202, may be applied in similar or analogous fashion to process, at least in part, one or more media streams 350.

In this embodiment, a set of items joined by the term “and/or” may mean any subset of the set of items. For example, in this embodiment, the phrase “A, B, and/or C” may mean the subset A (taken singly), the subset B (taken singly), the subset C (taken singly), the subset A and B, the subset A and C, the subset B and C, or the subset A, B, and C. Analogously, in this embodiment, a set of items joined by the phrase “at least one of may mean any subset of the set of items. For example, in this embodiment, the phrase “at least one of A, B, and/or C” may mean the subset A (taken singly), the subset B (taken singly), the subset C (taken singly), the subset A and B, the subset A and C, the subset B and C, or the subset A, B, and C.

Thus, in this embodiment, heretofore unavailable and/or advanced, high value-added services 410A . . . 410N may be provided, at least in part, by the one or more CCN 130 and/or C-RAN 131 themselves, based upon rich profile information 196. Advantageously, this may permit such heretofore unavailable services to be provided with greater efficiency, based upon highly targeted, specific, and tailored information related to the network, mobile devices, and users involved. Advantageously, this may permit such services to be provided in a manner that may result in a better user experience, may reduce latency, jitter, and/or wasted bandwidth, and may not necessitate that the wireless and/or cellular networks, and/or the mobile devices be changed.

Thus, in a first example in this embodiment, an apparatus is provided that may be usable in association, at least in part, with a network. The apparatus may comprise first circuitry and/or second circuitry. The first circuitry may be comprised, at least in part, in at least one cloud computing network. The first circuitry may generate, at least in part, at least one response to at least one service request. The at least one response may be based at least in part upon at least one service parameter and the at least one service request. The at least one cloud computing network may receive the at least one service request and the at least one service parameter via at least one wireless network. The second circuitry may be comprised, at least in part, in at least one mobile device. The at least one mobile device may communicate via the at least one wireless network. The second circuitry may generate, at least in part, the at least one service request. The at least one service parameter may be based at least in part upon profile information associated, at least in part, with the at least cloud computing network, the at least one wireless network, and the at least one mobile device.

In a second example of this embodiment that may comprise some or all of the elements of the first example, the at least one service request may request, at least in part, at least one of: (1) transcription processing of at least one media stream that is to be received, at least in part, at the at least one mobile device, (2) language translation processing of the at least one media stream, (3) modification processing, at least in part, of at least one encoding of the at least one media stream, (4) character recognition processing of at least one image, (5) image processing of the at least one image, and/or (6) volume normalization processing of the at least one media stream. In this second example, the transcription processing, the translation processing, the modification processing, the character recognition processing, the image processing, and/or the volume normalization processing may occur, at least in part, at the least one cloud computing network. The at least one mobile device may comprise at least one image capture device to capture, at least in part, the at least one image.

In a third example of this embodiment that may comprise some or all of the elements of the second example, the at least one media stream may comprise audio information and video information. The transcription processing may comprise real-time transcription into a local language of spoken content of the audio information. The local language may be determined based at least in part upon the profile information. The local language may be associated with a location of the at least one mobile device. The translation processing may comprise providing real-time translation of the spoken content into the local language. The modification processing may comprise changing the at least one encoding of the at least one media stream so as to be appropriate for playback by the at least one mobile device. The image capture device may comprise at least one camera to generate, at least in part, at least one other media stream that comprises the at least one image. The image processing may comprise image normalization and correction processing. In a fourth example of this embodiment that may comprise some or all of the elements of any of the preceding examples, the profile information may be based, at least in part, upon (1) usage and configuration information associated, at least in part, with the at least one mobile device and the at least one wireless network, (2) service agreement information associated with at least one user of the at least one cloud computing network, and/or (3) load balancing information associated, at least in part, with the at least one wireless network and the at least one cloud computing network.

In a fifth example of this embodiment that may comprise some or all of the elements of any of the preceding examples, the at least one wireless network may comprise at least one cellular network. The at least one mobile device may comprise, at least in part, at least one cellular telephone. The at least one cloud computing network may comprise, at least in part, in at least one cloud radio access network. The at least one cloud computing network may comprise compute nodes to provide, at least in part, services in accordance with software-defined network service agreements.

In a sixth example of this embodiment that may comprise some or all of the elements of the fifth example, the at least one service request may request, at least in part, at least one of the services. The at least one response may comprise provision, at least in part, of the at least one of the services. The compute nodes may execute, at least in part, software processes to provide, at least in part, the services.

In a seventh example of this embodiment, one or more computer-readable memories are provided that store one or more instructions that when executed by a device result in the performance of operations that may comprise (1) the operations that may be performed by the apparatus in any of the apparatus' preceding examples, and/or (2) any combination of any of the operations performed by the apparatus in any of the apparatus' preceding examples. In an eighth example of this embodiment, a method is provided that may be implemented, at least in part, in association with a network. The method may comprise (1) the operations that may be performed by the apparatus in any of the apparatus' preceding examples, (2) any combination of any of the operations performed by apparatus in any of the apparatus' preceding examples, and/or (3) any combination of any of the operations that may be performed by execution of the one or more instructions stored in the computer-readable memory of the seventh example of this embodiment.

In a ninth example of this embodiment, means may be provided to carry out any of, and/or any combination of, the operations that may be performed by the method, apparatus, and/or computer-readable memory in any of the preceding examples. In a tenth example of this embodiment, machine-readable memory may be provided that may store instructions and/or design data, such as Hardware Description Language, that may define one or more subsets of the structures, circuitry, apparatuses, features, etc. described herein (e.g., in any of the preceding examples of this embodiment). Many alternatives, modifications, and/or variations are possible without departing from this embodiment.

What is claimed is:

1. A network-associable apparatus usable in association, at least in part, with a network, the apparatus comprising:
first circuitry to be comprised, at least in part, in at least one cloud computing network, the first circuitry to generate, at least in part, at least one response to at least one service request, the at least one response being based at least in part upon at least one service parameter and the at least one service request, the at least one cloud computing network to receive the at least one service request and the at least one service parameter via at least one wireless network, the at least one service request to be generated, at least in part, by second circuitry comprised, at least in part, in at least one mobile device that is to communicate via the at least one wireless network, the at least one service parameter being based at least in part upon profile information associated, at least in part, with the at least one cloud communicating network, the at least one wireless network, and the at least one mobile device.

2. The apparatus of claim 1, wherein:
the at least one service request requests, at least in part, at least one of:
transcription processing of at least one media stream that is to be received, at least in part, at the at least one mobile device;
language translation processing of the at least one media stream;
modification processing, at least in part, of at least one encoding of the at least one media stream;
character recognition processing of at least one image;
image processing of the at least one image;
volume normalization processing of the at least one media stream;
the at least one of the transcription processing, the translation processing, the modification processing, the character recognition processing, the image processing, and the volume normalization processing is to occur, at least in part, at the least one cloud computing network; and
the at least one mobile device comprises at least one image capture device to capture, at least in part, the at least one image.

3. The apparatus of claim 2, wherein:
the at least one media stream comprises audio information and video information;
the transcription processing comprises real-time transcription into a local language of spoken content of the audio information, the local language being determined based at least in part upon the profile information, the local language being associated with a location of the at least one mobile device;
the translation processing comprises providing real-time translation of the spoken content into the local language;
the modification processing comprises changing the at least one encoding of the at least one media stream so as to be appropriate for playback by the at least one mobile device;
the image capture device comprises at least one camera to generate, at least in part, at least one other media stream that comprises the at least one image; and
the image processing comprises image normalization and correction processing.

4. The apparatus of claim 1, wherein:
the profile information is based, at least in part, upon:
usage and configuration information associated, at least in part, with the at least one mobile device and the at least one wireless network;
service agreement information associated with at least one user of the at least one cloud computing network; and
load balancing information associated, at least in part, with the at least one wireless network and the at least one cloud computing network.

5. The apparatus of claim 1, wherein:
the at least one wireless network comprises at least one cellular network;
the at least one mobile device comprises, at least in part, at least one cellular telephone;
the at least one cloud computing network is comprised, at least in part, in at least one cloud radio access network; and
the at least one cloud computing network comprises compute nodes to provide, at least in part, services in accordance with software-defined network service agreements.

6. The apparatus of claim 5, wherein:
the at least one service request is to request, at least in part, at least one of the services;
the at least one response comprises provision, at least in part, of the at least one of the services;
the compute nodes are to execute, at least in part, software processes to provide, at least in part, the services.

7. A network-associated method implemented, at least in part, in association with a network, the method comprising:
generating, at least in part, by first circuitry, at least one response to at least one service request, the first circuitry to be comprised, at least in part, in at least one cloud computing network, the at least one response being based at least in part upon at least one service parameter and the at least one service request, the at least one cloud computing network to receive the at least one service request, the at least one cloud computing network to receive the at least one service request and the at least one service parameter via at least one wireless network, the at least one service request to be generated, at least in part, by second circuitry comprised, at least in part, in at least one mobile device that is to communicate via the at least one wireless network, the at least one service parameter being based at least in part upon profile information associated, at least in part, with the at least one cloud communicating network, the at least one wireless network, and the at least one mobile device.

8. The method of claim 7, wherein:
the at least one service request requests, at least in part, at least one of:
transcription processing of at least one media stream that is to be received, at least in part, at the at least one mobile device;
language translation processing of the at least one media stream;
modification processing, at least in part, of at least one encoding of the at least one media stream;
character recognition processing of at least one image;
image processing of the at least one image;
volume normalization processing of the at least one media stream;
the at least one of the transcription processing, the translation processing, the modification processing, the character recognition processing, the image processing, and the volume normalization processing is to occur, at least in part, at the least one cloud computing network; and
the at least one mobile device comprises at least one image capture device to capture, at least in part, the at least one image.

9. The method of claim 8, wherein:
the at least one media stream comprises audio information and video information;
the transcription processing comprises real-time transcription into a local language of spoken content of the audio information, the local language being determined based at least in part upon the profile information, the local language being associated with a location of the at least one mobile device;
the translation processing comprises providing real-time translation of the spoken content into the local language;
the modification processing comprises changing the at least one encoding of the at least one media stream so as to be appropriate for playback by the at least one mobile device;
the image capture device comprises at least one camera to generate, at least in part, at least one other media stream that comprises the at least one image; and
the image processing comprises image normalization and correction processing.

10. The method of claim 7, wherein:
the profile information is based, at least in part, upon:
usage and configuration information associated, at least in part, with the at least one mobile device and the at least one wireless network;
service agreement information associated with at least one user of the at least one cloud computing network; and
load balancing information associated, at least in part, with the at least one wireless network and the at least one cloud computing network.

11. The method of claim 7, wherein:
the at least one wireless network comprises at least one cellular network;
the at least one mobile device comprises, at least in part, at least one cellular telephone;
the at least one cloud computing network is comprised, at least in part, in at least one cloud radio access network; and
the at least one cloud computing network comprises compute nodes to provide, at least in part, services in accordance with software-defined network service agreements.

12. The method of claim 11, wherein:
the at least one service request is to request, at least in part, at least one of the services;
the at least one response comprises provision, at least in part, of the at least one of the services;
the compute nodes are to execute, at least in part, software processes to provide, at least in part, the services.

13. One or more computer-readable memories storing one or more instructions that when executed by a device result in performance of operations comprising:
generating, at least in part, by first circuitry, at least one response to at least one service request, the first circuitry to be comprised, at least in part, in at least one cloud computing network, the at least one response being based at least in part upon at least one service parameter and the at least one service request, the at least one cloud computing network to receive the at least one service request, the at least one cloud computing network to receive the at least one service request and the at least one service parameter via at least one wireless network, the at least one service request to be generated, at least in part, by second circuitry comprised, at least in part, in at least one mobile device that is to communicate via the at least one wireless network, the at least one service parameter being based at least in part upon profile information associated, at least in part, with the at least one cloud communicating network, the at least one wireless network, and the at least one mobile device.

14. The one or more memories of claim 13, wherein:
the at least one service request requests, at least in part, at least one of:
transcription processing of at least one media stream that is to be received, at least in part, at the at least one mobile device;
language translation processing of the at least one media stream;
modification processing, at least in part, of at least one encoding of the at least one media stream;
character recognition processing of at least one image;
image processing of the at least one image;
volume normalization processing of the at least one media stream;
the at least one of the transcription processing, the translation processing, the modification processing, the character recognition processing, the image processing, and the volume normalization processing is to occur, at least in part, at the least one cloud computing network; and
the at least one mobile device comprises at least one image capture device to capture, at least in part, the at least one image.

15. The one or more memories of claim 14, wherein:
the at least one media stream comprises audio information and video information;
the transcription processing comprises real-time transcription into a local language of spoken content of the audio information, the local language being determined based at least in part upon the profile information, the local language being associated with a location of the at least one mobile device;
the translation processing comprises providing real-time translation of the spoken content into the local language;
the modification processing comprises changing the at least one encoding of the at least one media stream so as to be appropriate for playback by the at least one mobile device;
the image capture device comprises at least one camera to generate, at least in part, at least one other media stream that comprises the at least one image; and
the image processing comprises image normalization and correction processing.

16. The one or more memories of claim 13, wherein:
the profile information is based, at least in part, upon:
usage and configuration information associated, at least in part, with the at least one mobile device and the at least one wireless network;
service agreement information associated with at least one user of the at least one cloud computing network; and
load balancing information associated, at least in part, with the at least one wireless network and the at least one cloud computing network.

17. The one or more memories of claim 13, wherein:
the at least one wireless network comprises at least one cellular network;
the at least one mobile device comprises, at least in part, at least one cellular telephone;
the at least one cloud computing network is comprised, at least in part, in at least one cloud radio access network; and
the at least one cloud computing network comprises compute nodes to provide, at least in part, services in accordance with software-defined network service agreements.

18. The memory of claim 17, wherein:
the at least one service request is to request, at least in part, at least one of the services;
the at least one response comprises provision, at least in part, of the at least one of the services;
the compute nodes are to execute, at least in part, software processes to provide, at least in part, the services.

19. A network-associated apparatus usable in association, at least in part, with a network, the apparatus comprising:
first means to be comprised, at least in part, in at least one cloud computing network, the first means to generate, at least in part, at least one response to at least one service request, the at least one response being based at least in part upon at least one service parameter and the at least one service request, the at least one cloud computing network to receive the at least one service request and the at least one service parameter via at least one wireless network, the at least one service request to be generated, at least in part, by second means comprised, at least in part, in at least one mobile device that is to communicate via the at least one wireless network, the at least one service parameter being based at least in part upon profile information associated, at least in part, with the at least one cloud communicating network, the at least one wireless network, and the at least one mobile device

20. The apparatus of claim 19, wherein:
the at least one service request requests, at least in part, at least one of:
transcription processing of at least one media stream that is to be received, at least in part, at the at least one mobile device;
language translation processing of the at least one media stream;
modification processing, at least in part, of at least one encoding of the at least one media stream;
character recognition processing of at least one image;
image processing of the at least one image;
volume normalization processing of the at least one media stream;
the at least one of the transcription processing, the translation processing, the modification processing, the character recognition processing, the image processing, and the volume normalization processing is to occur, at least in part, at the least one cloud computing network; and
the at least one mobile device comprises at least one image capture device to capture, at least in part, the at least one image.

21. The apparatus of claim 20, wherein:
the at least one media stream comprises audio information and video information;
the transcription processing comprises real-time transcription into a local language of spoken content of the audio information, the local language being determined based at least in part upon the profile information, the local language being associated with a location of the at least one mobile device;
the translation processing comprises providing real-time translation of the spoken content into the local language;
the modification processing comprises changing the at least one encoding of the at least one media stream so as to be appropriate for playback by the at least one mobile device;
the image capture device comprises at least one camera to generate, at least in part, at least one other media stream that comprises the at least one image; and
the image processing comprises image normalization and correction processing.

22. The apparatus of claim 19, wherein:
the profile information is based, at least in part, upon:
usage and configuration information associated, at least in part, with the at least one mobile device and the at least one wireless network;
service agreement information associated with at least one user of the at least one cloud computing network; and
load balancing information associated, at least in part, with the at least one wireless network and the at least one cloud computing network.

23. The apparatus of claim 19, wherein:
the at least one wireless network comprises at least one cellular network;
the at least one mobile device comprises, at least in part, at least one cellular telephone;
the at least one cloud computing network is comprised, at least in part, in at least one cloud radio access network; and
the at least one cloud computing network comprises compute nodes to provide, at least in part, services in accordance with software-defined network service agreements.

24. The apparatus of claim 23, wherein:
the at least one service request is to request, at least in part, at least one of the services;
the at least one response comprises provision, at least in part, of the at least one of the services;
the compute nodes are to execute, at least in part, software processes to provide, at least in part, the services.
